(19) United States
(12) Patent Application Publication
(10) Pub. No.: US 2017/0124551 A1
(43) Pub. Date: May 4, 2017

(54) USING DEVICE LOCATION INFORMATION TO GENERATE CODES

(71) Applicant: PAYPAL, INC., San Jose, CA (US)

(72) Inventors: Jalpesh K. Chitalia, Sunnyvale, CA (US); Ansar Ansari, San Jose, CA (US); Karun Viswanath, Foster City, CA (US); Attaullah M. Baig, Round Rock, TX (US); Sireesh Potireddy, Santa Clara, CA (US); Catherine Wong, San Ramon, CA (US); Gavin Phillips, Sydney (AU); Darrell Esch, San Jose, CA (US); Malik Velani, Dallas, TX (US); Upendra S. Mardikar, San Jose, CA (US)

(21) Appl. No.: 15/408,381

(22) Filed: Jan. 17, 2017

Related U.S. Application Data
(63) Continuation of application No. 13/931,691, filed on Jun. 28, 2013.
(60) Provisional application No. 61/821,172, filed on May 8, 2013.

(51) Int. Cl. G06Q 20/32; G06Q 20/38; G06K 19/06; G06Q 20/20

(52) U.S. Cl. CPC G06Q 20/3274; G06Q 20/202; G06Q 20/385; G06Q 20/3224; G06K 19/06028; G06K 19/06037

(57) ABSTRACT

Methods and systems for facilitating payments with a mobile device are described. The methods include detecting a location of a mobile device, receiving identifying information from a user through the mobile device when the mobile device is near at least one merchant, generating a payment code, transmitting the payment code to the mobile device, receiving the payment code and a payment request from a merchant, and processing the payment request.

### CROSS-REFERENCE TO RELATED APPLICATION

Pursuant to 35 U.S.C. §119(e), this application is a continuation application to U.S. patent application Ser. No. 13/931,691, filed Jun. 28, 2013 and claims priority to the filing date of U.S. Provisional Patent Application No. 61/821,172, filed May 8, 2013, which is incorporated by reference in its entirety.

### BACKGROUND

Field of the Invention

The present invention generally relates to financial transactions using a mobile device.

Related Art

Traditional payments made online, by phone, by mail, or at points of sale (POS) commonly involve the use of a credit card, debit card, gift card, check, cash, etc., and can often be inconvenient for a consumer. For example, a consumer needs to carry the cards, a checkbook, a form of identification, or cash. Thus, a need exists for systems and methods that are more efficient and convenient for the consumer.

### BRIEF DESCRIPTION OF THE FIGURES

FIG. 1 is a flowchart showing a method for facilitating payments with a mobile device according to an embodiment of the present disclosure;

FIG. 2 is a block diagram illustrating a system for facilitating payments with a mobile device according to an embodiment of the present disclosure; and

FIG. 3 is a block diagram of a system for implementing one or more components in FIG. 2 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes the use of a payment code, e.g., an access code, such as a numeric string, alpha string, or an alphanumeric string, or a barcode, such as a Quick Response (QR) code, to facilitate payment with a user device, e.g., a mobile device. The payment codes can be used to make a payment, identify a user, enable a digital wallet experience at the time of payment, and improve payment security. In various embodiments, the use of the payment code allows the user to apply loyalty rewards, offers, coupons, and store credit or gift cards to the transaction.

The access code, in one embodiment, includes a random selection of letters, numbers, and/or other types of characters such as symbols (e.g., punctuation marks, emoticons, etc.). In some embodiments, the access code consists of two to sixteen characters, although different code lengths are also possible.

The barcode is a coded pattern of graphical indicia that includes of a series of stripes and spaces of varying widths, the stripes and spaces having differing light reflecting characteristics. Some of the more popular barcode symbologies include: Uniform Product Code (UPC), typically used in retail stores sales; Data Matrix, typically used for labeling small electronic products; Code 39, primarily used in inventory tracking; and Postnet, which is used for encoding zip codes for U.S. mail. Barcodes may be one dimensional (1D), i.e., a single row of graphical indicia that carry information in one direction, such as a UPC bar code, or two dimensional (2D), i.e., multiple rows of graphical indicia that carry information in two directions, such as Data Matrix which includes multiple rows and columns of black and white square modules arranged in a square or rectangular pattern. Other examples of 2D barcodes include PDF417, MaxiCode, Aztec™ barcode, and the QR Code. A QR code is a matrix barcode, readable by QR scanners, mobile phones with a camera, and smartphones. The QR code consists of modules arranged in a square pattern on a white background. The information encoded can be text, a uniform resource locator (URL) or other data.

The systems and methods described herein facilitate payment to a merchant using a payment code that is generated by a payment service provider, such as PayPal®, Inc. of San Jose, Calif. The payment code can be used at a retail location during checkout. Based on the user's privacy settings and preferences, the payment code can be automatically generated when the user is physically close or near to the location, i.e., without a request from the user. By “near” is meant a predetermined distance from the location, such as within the same zip code, the same shopping mall, the same city, or within 12 feet. For instance, a payment code that can be used at any location at a specific mall or shopping center may be provided to the user. The payment code is associated with the user and in some embodiments, at least one merchant. The payment code can be used by the user to make a payment anywhere, such as a particular retail location, and to make a payment even without Internet access.

In various embodiments, the payment service provider receives identifying information from a user, such as login information (e.g., user name, password, etc.). The payment service provider then generates a payment code and transmits the payment code to the user. The user receives the payment code and transmits it back to the payment service provider during checkout. The payment service provider receives the payment code, along with a payment request from the merchant, and processes the payment request.

In one embodiment, the payment code includes a 4-character to 8-character access code (e.g., a numeric code, an alpha code, or alphanumeric code) that is entered at the POS, by either the user or the cashier. In certain aspects, the access code is not a secret or private code that cannot be shared because it is typically generated for one-time use and for a limited amount of time. In various embodiments, the number of characters can be dynamically changed to allow a larger number of users to pay at the same merchant location. For example, in the case of a three-character code that includes a mix of numbers and letters, the number of possible codes is 46,656 (36×36×36). If this number of codes is insufficient to meet the needs of users at a certain time, another character can be added to form a four-character code, which increases the number of possible codes to 1,679,616 (36×36×36×36). In other embodiments, the validity period of the access code can be dynamically changed so that the shortest possible character string is generated. For instance, the validity period of a three-character code can be set for about a half hour when it is determined that 46,656 possible codes is sufficient to meet the needs of users. If the number of users in the area becomes greater, however, the validity period can be shortened to about 5 to 10 minutes so that the character string need not be increased.

In some embodiments, the value of the access code can be converted into a barcode to automate payment. In other embodiments, the payment code already includes a barcode that can be scanned at the POS for automatic payment. In still other embodiments, both a barcode and access code are generated and provided to the user. Other machine readable codes may also be suitable.

Whether the payment code is an access code or a barcode, either code can be converted into a virtual card number at the POS to pay for a purchase. Moreover, use of the access code or barcode to make a payment allows a seamless commerce experience because loyalty rewards and points, discounts, offers, coupons, gift cards, and other merchant specific offers can be applied to the purchase at the time of payment.

Advantageously, the access code or the barcode may be used in different situations. For example, a user can provide the access code over the phone so that a digital wallet capability can be used for making a payment. The access code or barcode can be used at a physical store during checkout or when picking up items at a merchant location after shopping online. The access code can further be used to pay for a purchase by mail.

The user can control and set various limits on use of the payment code. For example, the user can limit the price of items to be purchased using the payment code, the places that the payment code can be used, the times of day the payment code can be used, types of items to be purchased with the payment code, etc.

Use of the payment code further facilitates identification of the user, his or her order, or his or her transaction, at the POS. In certain embodiments, the user is optionally authenticated a very short time prior to use of the code on their mobile application. The use of the mobile application provides access to the user's location, his or her device information, and user credentials. Having one or more of these pieces of information can build stronger identity authentication, and compensate for fewer characters of the access code at the time of payment.

The payment code advantageously acts as the user's identification so a user need not provide the typical forms of identification (e.g., driver's license, credit card, etc.) to prove identity when, for example, picking up an item that was previously ordered. Instead, the user's mobile device is used to facilitate stronger identity authentication and improve payment security to improve the user experience.

In one embodiment, a user authenticates his identity to a mobile application run by a payment service provider such as PayPal®, Inc. of San Jose, Calif., on a mobile device. The payment service provider identifies the user, generates the payment code, and transmits the payment code to the user's mobile device. The user then provides the merchant with the payment code. The payment code acts as the user's identification, as the payment code is generated with a valid login session or authorization.

In various embodiments, the payment service provider returns a picture of the user to the mobile device for secondary authentication at the POS. The cashier can compare the picture to the face of the user in front of him to further verify the consumer's identity.

Use of the payment code also enables a secure, branded way of including enhanced wallet capabilities such as relevant offers, coupons, loyalty cards, gift cards, and store cards at the time of purchase. At the time of a user's request to generate the payment code, a notification is sent to a merchant about “potential business” and a unique payment service provider identifier of the user can be sent. Based on the user's preference and privacy settings, the merchant may be allowed to access the user's digital wallet as he or she applies for commerce transactions at a merchant (e.g., relevant loyalty cards, coupons, etc.) and/or to push offers to the user's account. In various embodiments, the merchant is provided with a “one time handle” to the user's account for pushing existing offers. These existing offers can be saved in the user's account and applied at the time of purchase.

In some embodiments, when the user receives the payment code, he or she may send the payment code to a delegate, who can then use the payment code to purchase an item or service. The delegate may be a friend, employee, or a child of the user. In one or more embodiments, the delegate may first send a message to the user to ask for money to make a purchase, and the user may then send the payment code to the delegate. In other embodiments, the user may send the payment code to the delegate, along with instructions on what item to purchase.

In various embodiments, the user can set limits on the payment code when it is to be used by a delegate. For example, the user may decide to pay for the purchase at the time of payment code generation or before sending the payment code to the delegate. The delegate can then use the payment code as identification to pick up the item from the store. In another instance, the user intends to purchase an item, but may not yet be ready to pay or may want to know the price of the item before purchase. The user sends the payment code to the delegate. The delegate goes to the store and can contact the user with item details and pay for the purchase by providing the payment code to the cashier.

The methods and systems described herein allow an end to end commerce experience for consumers, retailers, and financial partners. It also enables a notification agreement (one time handle, with expiry time) to limit consumer spam and yet enable relevant marketing. The one-time handle could be used by retailers and financial partners to send notifications to the consumer about a new store opening, new items available, or even to send a thank you for shopping. The methods and systems described herein make the consumer payment experience convenient and allow the consumer to use their mobile device to build a secure experience.

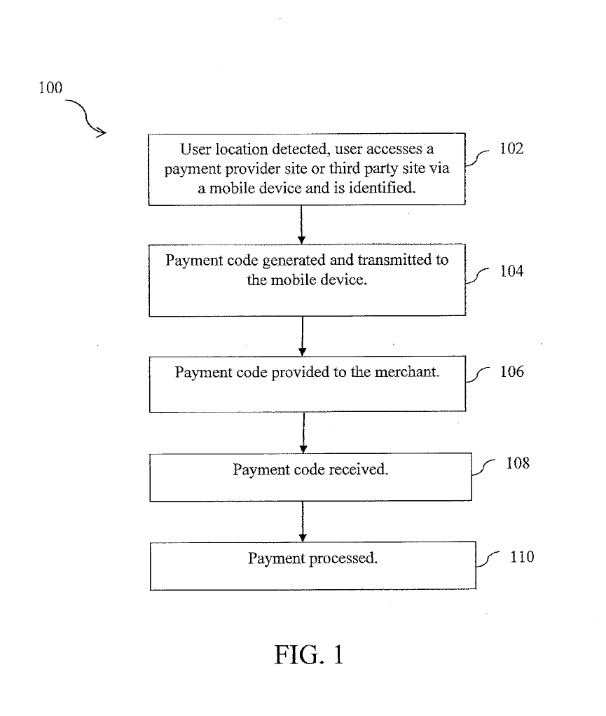

Referring now to FIG. 1, a flowchart of a method 100 for facilitating payments with a mobile device is illustrated according to an embodiment of the present disclosure. In an embodiment, at step 102, the location of the user is detected, a user accesses a payment service provider site or a third party site via a mobile device, and the user is identified and/or authenticated. The payment service provider or third party site automatically becomes available on the mobile device when the mobile device is close to or near at least one merchant. That is, the payment service provider or third party site becomes available to the user without a request from the user. The third party site may have been previously authorized by the user to act on their behalf. The location of the user cannot always be detected or approximated based on the location of the mobile device. In those cases, the risk associated with the transaction can be evaluated using, for example, the user's consumer history, merchant history, and other data based on the user's experience.

The user provides identifying data, e.g., user name, password, etc. In certain embodiments, the user selects one or more merchants that he or she is interested in. In other embodiments, the payment service provider detects the location of the user and provides a list of merchants that are nearby.

In one embodiment, the user registers with a payment service provider, which runs the mobile application. Registration may include signing up for the service and agreeing to any terms required by the payment service provider, such as through a user device. In one embodiment, the user device is a mobile computing device, such as a smart phone, a PC, or a computing tablet. In other embodiments, registration may be done completely through the user device, partially through the user device, or without using the user device, such as through a phone call or in-person visit to a representative of the payment service provider.

The user may be requested to provider specific information for registration, such as, but not limited to, a name, address, phone number, email address, picture, a user name for the account, and a password or PIN for the account. The type of information may depend on whether the user already has an account with the payment service provider. Requested information may be entered through the user device or other means, including voice or manual key entry. Once all the requested information is received and confirmed, the payment service provider may create an account for the user.

At step 104, the payment service provider generates and sends a payment code (e.g., an access code or barcode) to the mobile device without a request from the user, i.e., automatically. The code can be time sensitive and/or for one-time use. In certain embodiments, the payment code is location specific. For example, the payment code can only be used at specific locations such as a specific store or retailer, a zip code, a geo-location, or an area that is a certain distance or radius from a geo-location. In other embodiments, different and/or additional limitations or restrictions may be associated with the payment code, such as amount, time of use, type of purchase, etc.

The payment code, in one embodiment, includes a random selection of numbers and letters. In some exemplary embodiments, the payment code may be a random one-time use code that is generated by the payment service provider executing a random character generation program. The payment code may be sent to the user's mobile device in any suitable way, including by email, phone, text, or push notification.

Before or after the code is generated, the user may browse and select items that he or she wishes to purchase. At step 106, when the user is ready to pay for the purchase, the code is provided to the merchant For example, the code can be input by the user or a cashier at a POS, the code is input during online checkout, or if the code is a barcode, the code is scanned by the cashier.

In certain embodiments, the user has a limited amount of time to present the code to the merchant. If the user does not provide the code within a given time period, the payment service provider may operate to cancel use of the code.

In some embodiments, a physical location of the mobile device is compared to the location of the merchant store to determine if they match or if the distance between the mobile device and the merchant is acceptable. If it is determined that the locations match, the code may be used for payment.

The user may release geo-location information to the payment service provider by, e.g., setting release parameters. In one aspect, the user geo-location information includes user information related to a physical location or position of the mobile device, which are passed to the payment service provider via a network. The user geo-location information may include global positioning system (GPS) coordinates (e.g., longitude and latitude) inherent to the mobile device, such as a mobile cellular phone, and/or zip-code information. The user geo-location information may include user identifier information identifying the user. The user may manually set geo-location information, such as a zip code and/or longitude and latitude coordinates.

At step 108, the payment service provider receives the code and a request for payment from the merchant. The code is verified by the payment service provider as the code that is associated with the user and specific merchant, including any other limitations or restrictions associated with the payment code. In various embodiments, the payment service provider returns applicable rewards, coupons, store credit, gift cards, etc. to the merchant, to be applied to the transaction, and the amount for payment is reduced accordingly.

At step 110, the payment service provider approves and processes the payment request. After processing, the payment service provider may then transmit a notification to the user and/or the merchant.

### EXAMPLE

A particular example will now be described. A user checks in on his mobile device to shop at a specific store. When the consumer physically goes near the store, the PayPal® mobile application automatically pops up on the mobile device and shows the stores where the user has checked in, without a request from the user. In certain embodiments, there is a “Pay near me” button on the mobile device. An access code or barcode that can be used at any of the stores near the user can then be automatically generated by PayPal®. In some embodiments, the PayPal® app can automatically determine when the user is within a certain distance from the store. The app provides PayPal® with the device information, consumer session information, the retailer location and the geo-location of the mobile device.

PayPal® verifies that the user's mobile device is a registered device and that the user is within a certain distance from the merchant store, and automatically generates a 4-character payment code, e.g., a 4-digit code, to be used at this specific merchant location, without a request from the user. The code expires in a very short period of time (e.g., 15-30 minutes). During checkout, the user shows the code to the cashier. The cashier enters the code on the electronic point of sale (ePOS). The ePOS contacts PayPal® with the 4-character payment code. PayPal® returns coupons and/or loyalty information to the ePOS. The ePOS applies the loyalty and coupon information and submits a payment authorization with the original 4-character payment code to PayPal®. PayPal® approves the payment, and sends a notification to the user.

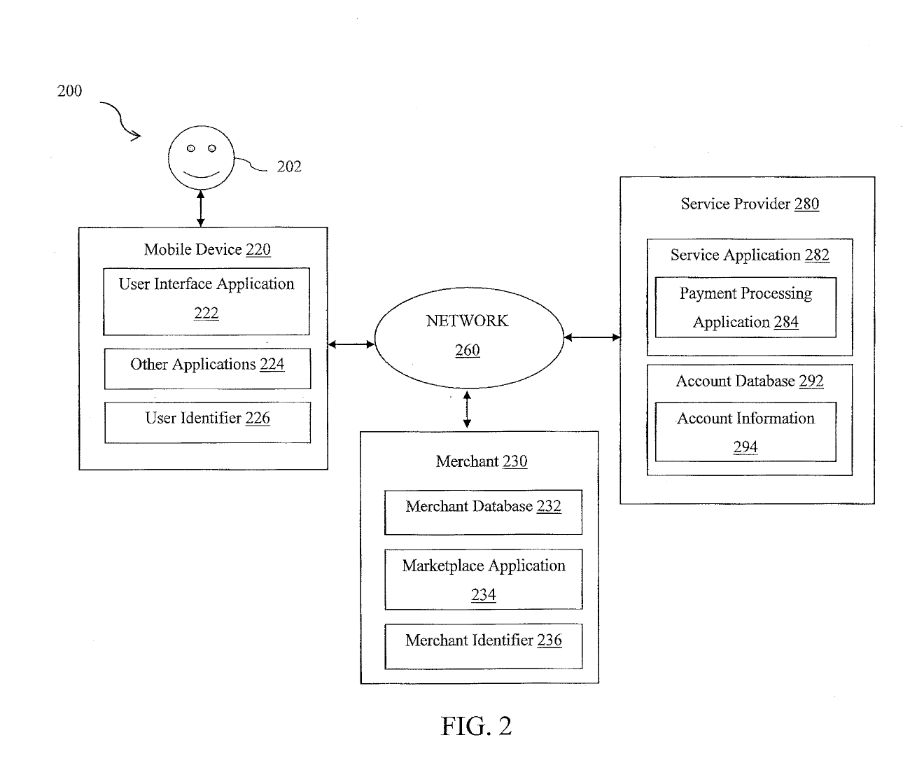

FIG. 2 shows one embodiment of a block diagram of a network-based system 200 adapted to facilitate payment using a mobile device 220 over a network 260. As shown, system 200 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 2 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 2, the system 200 includes a mobile device 220 (e.g., a smartphone), one or more merchant servers or devices 230 (e.g., network server devices), and at least one payment service provider server or device 280 (e.g., network server device) in communication over the network 260. The network 260, in one embodiment, may be implemented as a single network or a combination of multiple networks. For example, in various embodiments, the network 260 may include the Internet and/or one or more intranets, landline networks, wireless networks, and/or other appropriate types of communication networks. In another example, the network 260 may comprise a wireless telecommunications network (e.g., cellular phone network) adapted to communicate with other communication networks, such as the Internet. As such, in various embodiments, the mobile device 220, merchant servers or devices 230, and payment service provider server or device 280 may be associated with a particular link (e.g., a link, such as a URL (Uniform Resource Locator) to an IP (Internet Protocol) address).

The mobile device 220, in one embodiment, may be utilized by the user 202 to interact with the service provider server 280 over the network 260. For example, the user 202 may conduct financial transactions (e.g., account transfers) with the payment service provider server 280 via the mobile device 220. The mobile device 220, in various embodiments, may be implemented using any appropriate combination of hardware and/or software configured for wired and/or wireless communication over the network 260. The mobile device 220, in one embodiment, may be utilized by the user 202 to interact with the payment service provider server 280 over the network 260. For example, the user 202 may conduct financial transactions (e.g., account transfers) with the payment service provider server 280 via the mobile device 220. In various implementations, the mobile device 220 may include at least one of a wireless cellular phone, personal digital assistant (PDA), satellite phone, etc.

The mobile device 220, in one embodiment, includes a user interface application 222, which may be utilized by the user 202 to conduct transactions (e.g., shopping, purchasing, bidding, etc.) with the merchant server or device 230 or with the payment service provider server 280 over the network 260. In one aspect, purchase expenses may be directly and/or automatically debited from an account related to the user 202 via the user interface application 222.

In one implementation, the user interface application 222 comprises a software program, such as a graphical user interface (GUI), executable by a processor that is configured to interface and communicate with the payment service provider server 280 via the network 260. In another implementation, the user interface application 222 comprises a browser module that provides a network interface to browse information available over the network 260. For example, the user interface application 222 may be implemented, in part, as a web browser to view information available over the network 260.

In an example, the user 202 is able to access merchant websites via the one or more merchant servers 230 to view and select items for purchase, and the user 102 are able to purchase items from the one or more merchant servers 230 via the service provider server 280. Accordingly, in one or more embodiments, the user 202 may conduct transactions (e.g., purchase and provide payment for one or more items) from the one or more merchant servers 230 via the service provider server 280.

The mobile device 220, in various embodiments, may include other applications 224 as may be desired in one or more embodiments of the present disclosure to provide additional features available to user 202. In one example, such other applications 224 may include security applications for implementing client-side security features, programmatic client applications for interfacing with appropriate application programming interfaces (APIs) over the network 260, and/or various other types of generally known programs and/or software applications. In still other examples, the other applications 224 may interface with the user interface application 222 for improved efficiency and convenience.

In various implementations, a user profile may be created using data and information obtained from cell phone activity over the network 260. Cell phone activity transactions may be used by the payment service provider server 280 to create at least one user profile for the user 202 based on activity from the mobile device 220 (e.g., cell phone). The user profile may be updated with each financial and/or information transaction (e.g., payment transaction, purchase transaction, etc.) achieved through use of the mobile device 220. In various aspects, this may include the type of transaction and/or the location information from the mobile device 220. As such, the profile may be used for recognizing patterns of potential fraud, setting transaction limits on the user, etc.

The mobile device 220, in one embodiment, may include at least one user identifier 226, which may be implemented, for example, as operating system registry entries, cookies associated with the user interface application 222, identifiers associated with hardware of the mobile device 220, or various other appropriate identifiers. The user identifier 226 may include one or more attributes related to the user 202, such as personal information related to the user 202 (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the user identifier 226 may be passed with a user login request to the payment service provider server 280 via the network 260, and the user identifier 226 may be used by the payment service provider server 280 to associate the user 202 with a particular user account maintained by the payment service provider server 280.

In various implementations, the user 202 is able to input data and information into an input component (e.g., a keyboard) of the mobile device 220 to provide user information with a transaction request, such as a fund transfer request. The user information may include user identification information.

The mobile device 220, in one embodiment, includes a geo-location component adapted to monitor and provide an instant geographical location (i.e., geo-location) of the mobile device 220. In one implementation, the geo-location of the mobile device 220 may include GPS coordinates, zip-code information, area-code information, street address information, and/or various other generally known types of geo-location information. In one example, the geo-location information may be directly entered into the mobile device 220 by the user 202 via a user input component, such as a keyboard, touch display, and/or voice recognition microphone. In another example, the geo-location information may be automatically obtained and/or provided by the mobile device 220 via an internal or external GPS monitoring component. In other embodiments, the geo-location can be automatically obtained without the use of GPS. In some instances, cell signals or wireless signals are used. This helps to save battery life and to allow for better indoor location where GPS typically does not work.

In one aspect, when interfacing with the mobile device 220, the user 202 may elect to provide or may be prompted to provide permission for the release of geo-location information. Accordingly, the user 202 may have exclusive authority to allow transmission of geo-location information from the mobile device 220 to the one or more merchant devices 230 and/or the payment service provider server 280. In any instance, the one or more merchant devices 230 and/or the payment service provider server 280 may communicate with the mobile device 220 via the network 260 and request permission to acquire geo-location information from the mobile device 220 for geo-location based mobile commerce.

The one or more merchant servers 230, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of the user identity information as part of offering the items to the user 202 over the network 260. As such, each of the one or more merchant servers 230 may include a merchant database 232 for identifying available items, which may be made available to the mobile device 220 for viewing and purchase by the user 202. In one or more embodiments, user 202 may complete a transaction such as purchasing the items via payment service provider server 280.

Each of the merchant servers 230, in one embodiment, may include a marketplace application 234, which may be configured to provide information over the network 260 to the user interface application 222 of the mobile device 220. For example, user 202 may interact with the marketplace application 234 through the user interface application 222 over the network 260 to search and view various items available for purchase in the merchant database 232.

Each of the merchant servers 230, in one embodiment, may include at least one merchant identifier 236, which may be included as part of the one or more items made available for purchase so that, e.g., particular items are associated with particular merchants. In one implementation, the merchant identifier 236 may include one or more attributes and/or parameters related to the merchant, such as business and banking information. In various embodiments, user 202 may conduct transactions (e.g., searching, selection, monitoring, purchasing, and/or providing payment for items) with each merchant server 230 via the payment service provider server 280 over the network 260.

A merchant website may also communicate (for example, using merchant server 230) with the service provider through payment service provider server 280 over network 260. For example, the merchant website may communicate with the payment service provider in the course of various services offered by the payment service provider to merchant website, such as payment intermediary between customers of the merchant website and the merchant website itself For example, the merchant website may use an application programming interface (API) that allows it to offer sale of goods in which customers are allowed to make payment through the payment service provider, while user 202 may have an account with the payment service provider that allows user 202 to use the payment service provider for making payments to merchants that allow use of authentication, authorization, and payment services of payment service provider as a payment intermediary. The merchant website may also have an account with the payment service provider.

The payment service provider server 280, in one embodiment, may be maintained by a transaction processing entity or an online service provider, which may provide processing for financial transactions and/or information transactions between the user 202 and one or more of the merchant servers 230. As such, the payment service provider server 280 includes a service application 282, which may be adapted to interact with the mobile device 220 and/or each merchant server 230 over the network 260 to facilitate the searching, selection, purchase, and/or payment of items by the user 202 from one or more of the merchant servers 230. In one example, the payment service provider server 280 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 282, in one embodiment, utilizes a payment processing module 284 to process purchases and/or payments for financial transactions between the user 202 and each of the merchant servers 230. In one implementation, the payment processing module 284 assists with resolving financial transactions through validation, delivery, and settlement. As such, the service application 282 in conjunction with the payment processing module 284 settles indebtedness between the user 202 and each of the merchants 230, wherein accounts may be directly and/or automatically debited and/or credited of monetary funds in a manner as accepted by the banking industry.

The payment service provider server 280, in one embodiment, may be configured to maintain one or more user accounts and merchant accounts in an account database 292, each of which may include account information 294 associated with one or more individual users (e.g., user 202) and merchants (e.g., one or more merchants associated with merchant servers 230). For example, account information 294 may include private financial information of user 202 and each merchant associated with the one or more merchant servers 230, such as one or more account numbers, passwords, credit card information, banking information, or other types of financial information, which may be used to facilitate financial transactions between user 202, and the one or more merchants associated with the merchant servers 230. In various aspects, the methods and systems described herein may be modified to accommodate users and/or merchants that may or may not be associated with at least one existing user account and/or merchant account, respectively.

In one implementation, the user 202 may have identity attributes stored with the payment service provider server 280, and user 202 may have credentials to authenticate or verify identity with the payment service provider server 280. User attributes may include personal information, banking information and/or funding sources. In various aspects, the user attributes may be passed to the payment service provider server 280 as part of a login, search, selection, purchase, and/or payment request, and the user attributes may be utilized by the payment service provider server 280 to associate user 202 with one or more particular user accounts maintained by the payment service provider server 280.

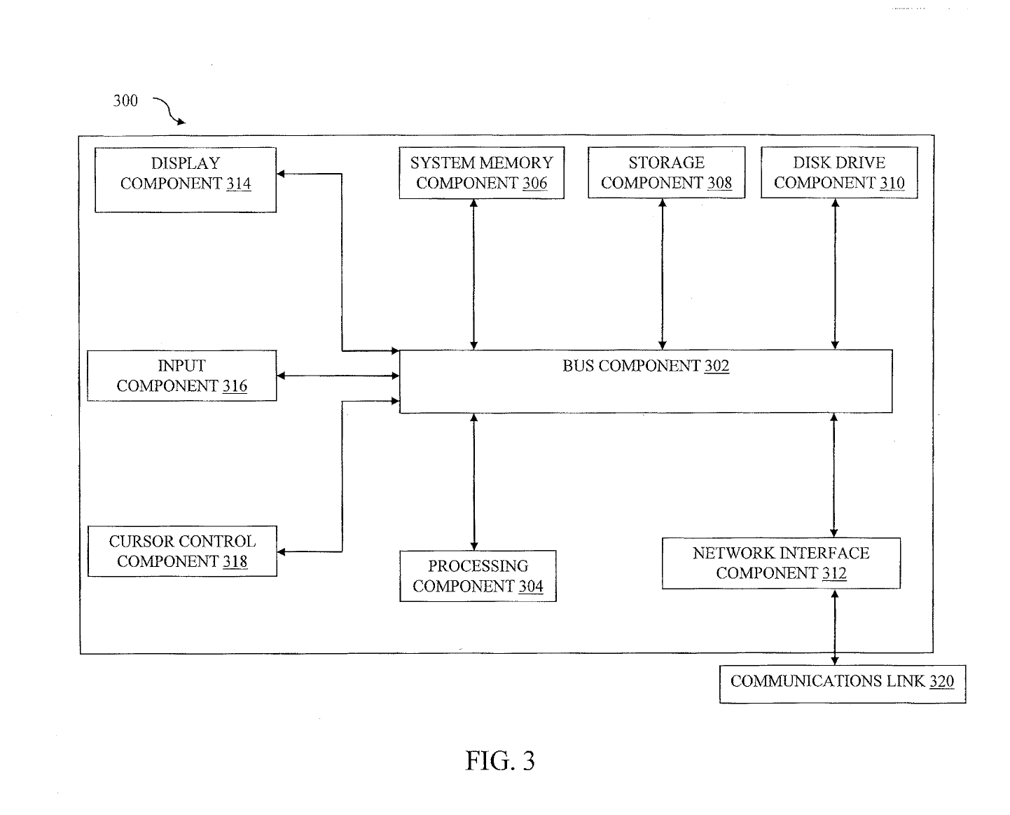

Referring now to FIG. 3, a block diagram of a system 300 is illustrated suitable for implementing embodiments of the present disclosure, including mobile device 220, one or more merchant servers or devices 230, and payment service provider server or device 280. System 300, such as part of a cell phone, a tablet, a personal computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 308 (e.g., ROM), a network interface component 312, a display component 314 (or alternatively, an interface to an external display), an input component 316 (e.g., keypad or keyboard), and a cursor control component 318 (e.g., a mouse pad).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to send and receive communications with links for tagged items, process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., network 260 of FIG. 2, LAN, WLAN, PTSN, or various other wired or wireless networks) may perform instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

In view of the present disclosure, it will be appreciated that various methods and systems have been described according to one or more embodiments for facilitating payment using a mobile device.

Although various components and steps have been described herein as being associated with user device 220, merchant server 230, and payment service provider server 280 of FIG. 2, it is contemplated that the various aspects of such servers illustrated in FIG. 2 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled to the non-transitory memory and configured to read instructions from the non-transitory memory to cause the system to perform operations comprising:
determining, based on location information corresponding to a mobile device, that the mobile device is located within a predetermined distance from a plurality of merchant locations;
in response to the determining, automatically generating a payment code, the payment code usable to indicate an account associated with a user of the mobile device for a purchase transaction at any merchant location of the plurality of merchant locations;
subsequent to the generating the payment code, dynamically adjusting at least one validation characteristic corresponding to the payment code based on a user population density within the predetermined distance of the plurality of merchant locations;
transmitting, to the mobile device via a wireless network, the payment code having the adjusted at least one validation characteristic, and the transmitting causing the mobile device to display the payment code;
receiving, via the wireless network, the payment code and a payment request from a point-of-sale (POS) device associated with a first merchant location of the plurality of merchant locations; and
processing the payment request based on the payment code.

2. The system of claim 1, wherein the payment code comprises an access code or a barcode.

3. The system of claim 1, wherein the payment code is automatically generated without receiving a request from a user of the mobile device.

4. The system of claim 1, wherein the operations further comprise applying rewards, points, discounts, offers, coupons, gift cards, or other merchant specific offers to the payment request.

5. The system of claim 1, wherein the operations further comprise transmitting a digital image of the user to the POS device to authenticate the user.

6. The system of claim 1, wherein the plurality of merchant locations correspond to merchant locations in which the user has checked in.

7. The system of claim 1, wherein the adjusting the at least one validation characteristic comprises adjusting a length of an alphanumeric code included in the payment code.

8. The system of claim 1, wherein the adjusting the at least one validation characteristic comprises adjusting a validation period corresponding to the payment code, the validation period indicating a period of time in which the payment code is usable for the purchase transaction at the plurality of merchant locations.

9. The system of claim 1 wherein the adjusting the at least one validation characteristic comprises:
adjusting a length of an alphanumeric code included in the payment code; and
adjusting a validation period corresponding to the payment code, the validation period indicating a period of time in which the payment code is usable for the purchase transaction at the plurality of merchant locations.

10. A method for facilitating payment with a mobile device of a user, comprising:
determining, by one or more hardware processors based on location information corresponding to a mobile device, that the mobile device is located within a predetermined distance from a plurality of merchant locations;
in response to the determining, automatically generating, by the one or more hardware processors a payment code that is usable to indicate an account associated with a user of the mobile device for a purchase transaction at any merchant location of the plurality of merchant locations;
subsequent to the generating the payment code, dynamically adjusting at least one validation characteristic corresponding to the payment code based on a user population density within the predetermined distance of the plurality of merchant locations;
transmitting, to the mobile device via a wireless network, the payment code having the adjusted at least one validation characteristic, and the transmitting causing the mobile device to display the payment code;
receiving, via the wireless network, the payment code and a payment request from a point-of-sale (POS) device associated with a first merchant location of the plurality of merchant locations; and
processing the payment request based on the payment code.

11. The method of claim 10, wherein the payment code comprises an access code or a quick response (QR) code.

12. The method of claim 10, wherein the payment code is automatically generated without receiving a request from a user of the mobile device.

13. The method of claim 10, further comprising transmitting a unique payment service provider identifier of the user to at least one merchant device corresponding to at least one merchant location of the plurality of merchant locations.

14. The method of claim 10, wherein the adjusting the at least one validation characteristic comprises adjusting a length of an alphanumeric code included in the payment code.

15. The method of claim 10, wherein the adjusting the at least one validation characteristic comprises adjusting a validation period corresponding to the payment code, the validation period indicating a period of time in which the payment code is usable for the purchase transaction at the plurality of merchant locations.

16. A non-transitory machine-readable medium having stored thereon machine-readable instructions executable to cause a machine to perform operations comprising:
determining, based on location information corresponding to a mobile device, that the mobile device is located within a predetermined distance from a plurality of merchant locations;
in response to the determining, automatically generating a payment code, the payment code usable to indicate an account associated with a user of the mobile device for a purchase transaction at any merchant location of the plurality of merchant locations;
subsequent to the generating the payment code, dynamically adjusting at least one validation characteristic corresponding to the payment code based on a user population density within the predetermined distance of the plurality of merchant locations;
transmitting, to the mobile device via a wireless network, the payment code having the adjusted at least one validation characteristic, and the transmitting causing the mobile device to display the payment code;
receiving, via the wireless network, the payment code and a payment request from a point-of-sale (POS) device associated with a first merchant location of the plurality of merchant locations; and
processing the payment request based on the payment code.

17. The non-transitory machine-readable medium of claim 16, wherein the payment code is for one-time use.

18. The non-transitory machine-readable medium of claim 16, wherein the operations further comprise applying rewards, points, discounts, offers, coupons, gift cards, or other merchant specific offers to the payment request.

19. The non-transitory machine-readable medium of claim 16, wherein the payment code is automatically generated without receiving a request from a user of the mobile device.

20. The non-transitory machine-readable medium of claim 16, wherein the adjusting the at least one validation characteristic comprises:
adjusting a length of an alphanumeric code included in the payment code; and
adjusting a validation period corresponding to the payment code, the validation period indicating a period of time in which the payment code is usable for the purchase transaction at the plurality of merchant locations.
